(19) United States
(12) Patent Application Publication
(10) Pub. No.: US 2026/0351027 A1
(43) Pub. Date: Nov. 5, 2026

(54) CELL PAINTING AND MACHINE LEARNING TO GENERATE LOW VARIANCE DISEASE MODELS

(71) Applicant: GOOGLE LLC, Mountain View, CA (US)

(72) Inventors: Phillip JESS, San Francisco, CA (US); Mike ANDO, South San Francisco, CA (US); Marc BERNDL, Mountain View, CA (US); Arun NARAYANASWAMY, Sunnyvale, CA (US)

(21) Appl. No.: 19/101,966

(22) PCT Filed: Aug. 7, 2023
(86) PCT No.: PCT/US2023/071784

§ 371 Date: Feb. 7, 2025

Related U.S. Application Data
(60) Provisional application No. 63/395,902, filed on Aug. 8, 2022.

(51) Int. Cl. G06V 20/69; G01N 1/30; G06T 7/00; G06V 10/56; G06V 10/75

(52) U.S. Cl. CPC G06V 20/698; G01N 1/30; G06T 7/0012; G06V 10/56; G06V 10/75

(57) ABSTRACT

Improved methods for cell line staining and cell identification are provided that allow multiple cell lines (e.g., control and non-control cell lines) to be incubated in the same sample well. These methods include selectively staining different morphological features of each cell line in a manner that permits later optical identification of the cell line when multiple different cell lines are incubated and imaged together. This permits reduced replicate requirements when screening drug libraries or performing other high throughput assessments, as multiple different cell lines can be subjected to identical incubation conditions by being incubated in the same sample well, subjected to the same variations in pipetting, incubation temperature, agitation, etc. Machine learning models used to identify which morphology-specific stain is present in each cell can also be leveraged to directly predict disease state based directly on morphological features, facilitating drug discovery and disease mechanism elucidation for rare diseases.

### CROSS-REFERENCE TO RELATED APPLICATION

This application claims priority to U.S. Provisional Patent Application No. 63/395,902, filed on Aug. 8, 2022, the contents of which are hereby incorporated by reference in their entirety.

### BACKGROUND

Drug discovery or other biological investigations (e.g., the elucidation of the underlying cellular and/or genetic mechanisms of a disease state) can be facilitated by high-throughput screening or other laboratory automation techniques. These techniques can include generating, incubating, imaging, or performing other processes on a large number of different biological samples by providing such samples in multi-well sample plates that can then be manipulated, seeded, stained, imaged, or have other laboratory processes performed thereon in a high-speed, automated fashion.

However, variation in cell medium, plating processes, incubation micro-environment, and other conditions from plate to plate and even from well to well on a single plate mean that many replicates of a particular experimental condition (e.g., the identity of an applied drug candidate) may be required across cell lines, wells, and/or plates in order to determine the effect of a drug or other experimental intervention (e.g., a genetic modification to a cell line) to a desired level of statistical confidence. As a result, evaluation of large drug libraries or performance of other complicated experimental evaluations can require very large numbers of samples.

This results in increased costs and time to perform such experimental evaluation. Accordingly, it can be cost-prohibitive to perform drug discovery or other such investigations for rare diseases. This can be related both to the relatively lesser funding available for such diseases, as well as to the increased difficulty in generating model cell lines and/or obtaining samples of sufficient size from sufficient numbers of people afflicted with the rare disease in order to allow statistically significant results to be obtained.

### SUMMARY

In a first aspect, a method is provided that includes: (i) staining a first cell line with a first stain and a second stain, wherein the first stain has a first color and stains first intracellular contents of the first cell line, wherein the second stain has a second color and stains second intracellular contents of the first cell line, wherein the first color differs from the second color, and wherein the first intracellular contents differ from the second intracellular contents; (ii) staining a second cell line with a third stain and a fourth stain, wherein the first stain has a third color and stains third intracellular contents of the second cell line, wherein the fourth stain has a fourth color and stains fourth intracellular contents of the second cell line, wherein the third color differs from the fourth color, wherein the third intracellular contents differ from the fourth intracellular contents, wherein the first color is the same as the third color, and wherein the first intracellular contents differ from the third intracellular contents; (iii) creating a first sample by adding at least one cell from the first cell line and at least one cell from the second cell line to a sample container; (iv) imaging the sample container to generate a first image of the first sample, wherein the first image depicts a first cell and a second cell; (v) determining, based on the first image, that the first cell is from the first cell line by determining (a) that the first intracellular contents of the first cell are stained with the first color, (b) that the second intracellular contents of the first cell are stained with the second color, and (c) that the pattern of staining of intracellular contents of the first cell matches the pattern of staining of the first cell line; and (vi) determining, based on the first image, that the second cell is from the second cell line by determining (a) that the third intracellular contents of the second cell are stained with the third color, (b) that the fourth intracellular contents of the second cell are stained with the fourth color, and (c) that the pattern of staining of intracellular contents of the second cell matches the pattern of staining of the second cell line.

In a second aspect, a computer-implemented method is provided that includes: (i) imaging a sample container to generate a first image of the first sample, wherein the first image depicts a first cell and a second cell, wherein the first sample includes at least one cell from a first cell line and at least one cell from a second cell line, wherein the first cell line has been stained with a first stain and a second stain, wherein the first stain has a first color and stains first intracellular contents of the first cell line, wherein the second stain has a second color and stains second intracellular contents of the first cell line, wherein the first color differs from the second color, wherein the first intracellular contents differ from the second intracellular contents, wherein the second cell line has been stained with a third stain and a fourth stain, wherein the first stain has a third color and stains third intracellular contents of the second cell line, wherein the fourth stain has a fourth color and stains fourth intracellular contents of the second cell line, wherein the third color differs from the fourth color, wherein the third intracellular contents differ from the fourth intracellular contents, wherein the first color is the same as the third color, and wherein the first intracellular contents differ from the third intracellular contents; (ii) determining, based on the first image, that the first cell is from the first cell line by determining (a) that the first intracellular contents of the first cell are stained with the first color, (b) that the second intracellular contents of the first cell are stained with the second color, and (c) that the pattern of staining of intracellular contents of the first cell matches the pattern of staining of the first cell line; and (iii) determining, based on the first image, that the second cell is from the second cell line by determining (a) that the third intracellular contents of the second cell are stained with the third color, (b) that the fourth intracellular contents of the second cell are stained with the fourth color, and (c) that the pattern of staining of intracellular contents of the second cell matches the pattern of staining of the second cell line.

In a third aspect, computer-implemented method is provided that includes: (i) imaging a sample container to generate a first image of the first sample, wherein the first image depicts a first cell and a second cell, wherein the first sample includes at least one cell from a first cell line and at least one cell from a second cell line, wherein the first cell line represents a disease state, and wherein the second cell line does not represent the disease state; (ii) determining, based on the first image, that the first cell is from the first cell line; (iii) determining, based on the first image, that the second cell is from the second cell line; and (iv) based on the first image, training a first machine learning model to predict, based on an input image of a target cell, whether the target cell represents the disease state.

In a fourth aspect, a non-transitory computer readable medium is provided having stored therein instructions executable by a computing device to cause the computing device to perform the method of the first, second, or third aspects.

In a fifth aspect, a system is provided that includes: (i) a controller comprising one or more processors; and (ii) a non-transitory computer readable medium having stored therein instructions executable by the controller device to cause the one or more processors to perform the method of the first, second, or third aspects.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE FIGURES

FIG. 1A illustrates contents of a first example image of a sample, according to example embodiments.

FIG. 1B illustrates contents of a second example image of the sample depicted in FIG. 1A, according to example embodiments.

FIG. 1C illustrates contents of a third example image of the sample depicted in FIG. 1A, according to example embodiments. FIG. 1C illustrates contents of a third example image of the sample depicted in FIG. 1A, according to example embodiments.

FIG. 1D illustrates contents of a third example image of the sample depicted in FIG. 1A, according to example embodiments.

FIG. 1E illustrates contents of a third example image of the sample depicted in FIG. 1A, according to example embodiments.

FIG. 1F illustrates contents of a third example image of the sample depicted in FIG. 1A, according to example embodiments.

FIG. 2 illustrates aspects of an example system.

FIG. 3 and FIG. 4 illustrate flowcharts of example methods.

FIG. 5 illustrates a flowchart of an example method.

FIG. 6 illustrates aspects of an example system.

### DETAILED DESCRIPTION

The following detailed description describes various features and functions of the disclosed systems and methods with reference to the accompanying figures. The illustrative system and method embodiments described herein are not meant to be limiting. It may be readily understood that certain aspects of the disclosed systems and methods can be arranged and combined in a wide variety of different configurations, all of which are contemplated herein.

### I. Overview

Drug discovery and a variety of other experimental techniques can be facilitated by incubating a number of different cell lines (some exhibiting a disease state or other characteristic of interest, and others being ‘controls’) in a large number of separate samples along with different candidate drugs, candidate therapies, genetic modifications, or other experimentally-varying conditions across the separate samples. The effects of the candidate drug or other applied experimental condition can then be assessed in each of the samples (e.g., as a cell count, a number or ratio of dead cells, statistics of cell area, roundness, or other internal or external morphological characteristics) and this information used to assess the efficacy or other properties of the applied experimental condition(s).

To reduce the cost, time, and materials required for such extensive experimental preparations, which can include tens of thousands of samples, robotic sample handling apparatus, multi-well sample plates, machine learning and image processing, high throughput screening, or other laboratory automation techniques can be applied. Despite these benefits, the cost to investigate a large library of drug candidates, or to perform other large-scale investigations, can remain prohibitive. This is due in part to variations in the experimental conditions experienced by each of the samples, which can be related to variations in incubation micro-environment, variations in pipetting and sample handling, variations in growth medium composition, or other sources of variation between the samples which can confound analysis of cell counts or other experimental outputs across the samples. To account for these variations, each cell line and applied drug (or other experimental condition) must be replicated a number of times, in order to improve the statistical power of any outcomes of the experiment. This replication further increases the cost of performing such investigations.

The systems and methods described herein improve high-sample-count experiments by permitting multiple different cell lines to be incubated in the same sample well. This allows the number of replicates to be reduced, since multiple different cell lines being incubated in the same sample well means that those different cell lines experience essentially the same incubation conditions, allowing their outcomes (e.g., with respect to an applied drug or other experimental intervention) to be directly compared, at least amongst the cell lines adequately represented in the same sample well. To allow the identification, with respect to cell line, of each cell in such a mixed well, each cell line is stained with a respective unique pattern of multiple different stains. Each stain has a respective color (e.g., a respective emission wavelength, excitation wavelength, and/or reflective or absorptive wavelength) and a respective specificity with respect to a different aspect of the intracellular contents of the cell line. So, for example, one stain could preferentially target actin, another could target nuclear membrane proteins, another could target the golgi body, another could target the rough endoplasmic reticulum, etc.

The pattern of staining, and of the colors of the stains, could thus be applied uniquely to each of the cell lines that are included in a sample well, in order to allow optical microscopy to be applied to identify the cell line of each cell in the sample. This can include applying the microscopy images to a rule-based algorithm, a machine learning model, and/or some other variety of model or filter in order to determine which intracellular targets in a particular cell are stained with which colors, and then to match the determined pattern of staining with the known patterns for each of the cell lines. Information about each of the cell lines in the sample (e.g., cell count, number/ratio of dead cells, size, roundness, nucleus size, machine learning-derived embeddings or other outputs representative of morphological characteristics, or other internal or external morphological characteristics) can then be determined and used in order to analyze the efficacy of drugs or other therapeutic interventions applied to the samples, to determine a mechanism of a disease or other physiological process by determining how different genetic modifications (e.g., knock outs, CRISPR edits) affect expression of the disease or physiological process, or to determine some other analysis related to a multi-sample experiment.

Such stains, which specifically stain particular intracellular contents, can also be used to derive morphological information about the cells which can then be used to predict whether a particular cell is exhibiting a disease state or other physiological characteristic of interest. This could include determining, for each cell in a sample, a binary output as to whether the cell has the disease (or other physiological) state or not or determining a continuous- or otherwise varying-valued output that represents a degree to which the cell represents the disease (or other physiological) state. Stain(s) used for such morphological disease state detection or prediction can be the same as those used to identify the cell line of the cells, and/or could include additional or alternative stains. For example, a first set of stains could be used to identify the cell line of cells in a sample, while a separate set of one or more stains could be used separately to determine the presence, degree, or other information about a disease or other physiological state of the cells.

Predictions determined based on such stain-derived cell morphological information can be used to facilitate assessment of drug efficacy, elucidation of the mechanism of a disease or other physiological state or process (e.g., by incubating a variety of cell lines with different knock-outs, CRISPR edits, or other genetic modifications), or other experimental investigations by allowing the effectiveness of a drug or other experimental intervention or variation to be assessed without particular knowledge of the underlying mechanism of the disease state in question or a gold-standard model for the disease state in question. These benefits can allow rare diseases, which generally have less resources allocated to their investigation and which have fewer examples available for study, to be more effectively investigated.

To generate an output prediction related to a disease (or other physiological) state for a cell based on such stain-derived morphological information, one or more images of the stained cell can be applied to a machine learning model (e.g., a convolutional neural network CNN) that has been trained to detect the disease (or other physiological) state based on such morphological image data. Such a model could be trained by, e.g., incubating a number of stained cell lines that exhibit the disease state (e.g., derived from patients experiencing the discase state) along with a number of stained cell lines that do not (“control” cell lines). Images of the incubated samples containing the disease and control cell lines can then be analyzed as described above to identify each cell's cell line. Images of the individual cells can then be labeled according to their cell line (e.g., “disease” or “control”) and the labeled training images applied to train a machine learning model to predict the disease state from novel input images. For example, images from a “control well” of a sample plate, containing both “disease” and “control” cell lines, could be used to train a machine learning model to predict the disease state. The trained model could then be applied to images of other wells of the plate, which have been subject to an experimental intervention (e.g., to which has been applied a candidate drug) in order to determine the expression of the disease state by “disease” cell lines to assess whether the intervention is effective in reducing (or increasing) the expression of the disease state (e.g., whether the candidate drug is likely effective in treating the disease state). Such an output could be used in addition to, or as an alternative to, other methods of assessing the effect of an intervention in a cell sample (e.g., cell counts, dead cell counts/ratios, cell size or other conventional morphological characteristics, etc.).

To improve the training of such a machine learning model to detect the disease state, the contents of the individual samples could be tailored. For example, “control” cell lines and “disease” cell lines could be matched with respect to demographic information (e.g., sex, age, etc.) such that such matched pairs are always both present in any particular sample well, to reduce the likelihood that the model output is trained to detect such demographic information. Additionally or alternatively, individual cell lines could be stained in multiple different patterns in respective different sample wells, to reduce the likelihood that the model output is trained to detect the disease state by detecting the particular staining patterns applied to the “disease” cell lines and to the “control” cell lines.

Another benefit of the systems and methods described herein is that they permit incubation and analysis of multiple cell lines in a single sample well without requiring sample destruction. Prior methods for incubating and analyzing multiple cell lines in a single sample well relied on destroying the sample in order to identify the individual cells via sequencing or other destructive analytical processes. In contrast, the methods described herein identify the cell lines, and their disease (or other physiological) state optically, and thus non-destructively. Accordingly, samples can be incubated further following imaging, allowing them to be imaged again subsequently. This allows longitudinal analysis to be performed, e.g., to detect dynamic changes in morphology that may be relevant to investigation of a disease state or other physiological state or process. The stain-based optical identification of cells in a sample also allows individual cells to be tracked within a sample over time despite relative movements of the cells within the sample, changes in shape, size or morphology, imperfections in alignment of imaging equipment with the sample container, or other changes in the imaging setup or sample over time.

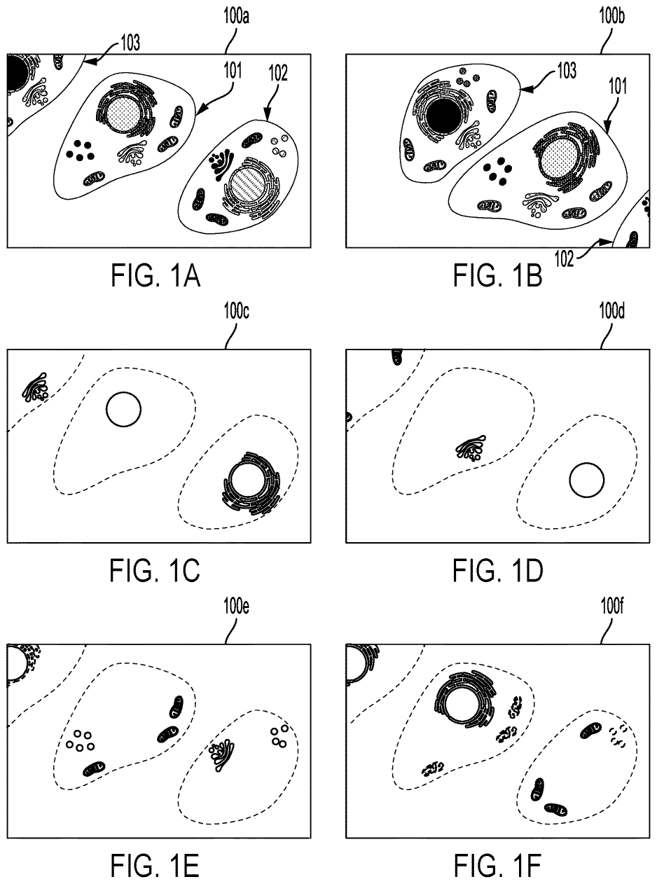

FIG. 1A depicts an example first image 100a of a sample that contains first 101, second 102, and third 103 cells taken from respective first, second, and third cell lines. The first image 100a is a hyperspectral image (e.g., a color image), with different-colored sample contents depicted, in the black-and-white representation of FIG. 1A, by respective different fill patterns. Each of the cell lines were created by staining the respective different cell lines with respective unique morphology-specific patterns of stains, as described above. So, for example, the nucleus of the first cell 101 and the endoplasmic reticulum of the second cell 102 have been stained the same first color, which, for purposes of description, will be called ‘green.’ To further define the non-limiting illustrative example depicted in FIG. 1A, (i) the golgi body of the first cell 101 and the third cell 103 and the nucleus of the second cell 102 have been stained the same second color, which, for purposes of description, will be called ‘blue;’ (ii) the peroxisomes of the first cell 101, the golgi body of the second cell 102, and the nucleus of the third cell 103 have been stained the same third color, which, for purposes of description, will be called ‘red;’ (iii) the mitochondria of the first cell 101 and the peroxisomes of the second cell 102 have been stained the same fourth color, which, for purposes of description, will be called ‘orange;’ and (iv) the endoplasmic reticulum of the first cell 101and the mitochondria of the second cell 102 have been stained the same second color, which, for purposes of description, will be called ‘yellow.’Each cell line is stained separately, and then cells taken from each and added together to produce samples (like the sample depicted by the first image 100a) that can then be incubated, experimentally probed, and imaged.

Note that these patterns of staining three different cells, the example ‘colors,’ and the identity and extent of the intracellular contents specifically stained by each stain are meant only as simplified, non-limiting examples provided for purposes of illustrating the embodiments described herein. Additional or alterative intracellular contents (e.g., organelles, proteins, RNA sequences, DNA sequences, etc.) and/or sets of intracellular contents could be commonly stained by a single stain and/or color within cells (e.g., multiple stains, targeted to respective different, but potentially overlapping, sets of intracellular contents, having the same color could be applied to the same cell line). Further, where an enumerated set of possible morphological stains is available (e.g., golgi, nucleus, mitochondria, peroxisomes, reticulum) and the efficiency of tagging is sufficiently high (such that a cell's contents not being stained is indicative of it having not been stained, rather than merely that the stain was not effective for that cell), “not stained” is a valid option when setting the pattern of staining for a cell line. To avoid experimental confounds, such a “not stained” cell could receive a stain that has “no color” by virtue of lacking a fluorophore, dye, or other color-causing element, by having a nonfunctional color-causing element (e.g., a denatured or mutated fluorophore), and/or by having a “color” that is outside the detection range (e.g., with respect to wavelength) of the imaging apparatus used to image the samples.

As noted above, this morphologically-specific cell staining (or ‘tagging’) allows the cells in a sample to be non-destructively optically identified, at least so far as membership in one of a set of enumerated cell lines that can be uniquely identified by the pattern of cell tagging. This allows samples to be imaged at multiple points in time, in order to observe dynamic patterns in cell count, cell morphology, or other properties of the cells in a sample. This repeated imaging functionality is facilitated by identification of the cells because this identification can account for changes in the sample (e.g., relative motion of the cells in the sample, cell death or reproduction, changes in cell size or morphology). This is illustrated by way of example in FIG. 1B, which depicts a second image 100b of the sample that is also depicted in the first image 100a, taken at a later time (e.g., subsequent to further incubation, application of additional or alternative candidate drugs or other experimental interventions, etc.). As depicted in the second image 100b, the first cell has moved down and to the right in the frame and rotated and changed size and shape, the second cell 102 has moved almost completely out of the frame of the second image 100b, and the third cell 103 has moved completely into the frame of the second image 100b. These changes in the second image 100b relative to the first image 100a could be due to a variety of factors, as detailed above. The presence of the morphologically-specific cell tagging in each of the cells 101, 102, 103 allows the identity of the cells depicted in the second image 100b to be determined from the second image 100b. This identification, potentially in combination with determining an overall shift of the frame of the image relative to the contents of the sample, allows the identity of the individual cells 101, 102, 103 to be tracked from one image (e.g., 100a) to the next (e.g., 100b). Such tracking might be possible in the absence of cell-line-specific cell tagging (e.g., by tracking patterns of cells, cells shapes, etc. from one image to the next), but the addition of the morphologically-specific cell tagging allows this tracking to be performed more easily and with higher accuracy.

Identifying the pattern of intracellular contents-specific staining of a cell can be performed in a variety of different ways. For example, the imaging data corresponding to a particular cell could be applied to a rule-based model and/or to one or more machine learning models that have been trained to identify which intracellular contents of a cell have been stained and/or with which color(s). This could include applying one or more images of a cell, that correspond to the color of a stain that is present in a cell, to a rule-based model and/or a machine learning model (e.g., a CNN) that has been trained to determine, based on such input image(s), which intracellular contents (e.g., from an enumerated list of possible sets of specifically-stained intracellular contents) have been stained within the cell. These determinations, along with information about the color of the input images, could then be used to determine the pattern of staining of a particular cell and, from that information, to determine the cell line of the particular cell.

Aspects of such a process can be illustrated by reference to FIGS. 1C-1F, which depict respective different component images (e.g., respective different single-wavelength-range images of a hyperspectral image) of the color image 100a of the sample. As shown, the color image 100a is composed of four separate component images 100c, 100d, 100e, and 100f, which depict the ‘green,’ ‘blue,’ ‘red,’ and ‘yellow’ colors in the image 100a, respectively. However, imagery of a sample could include more or fewer component images, corresponding to different ‘colors’ or ranges of wavelengths. The extent of the regions of each image that represent each of the cells 101, 102, 103 are indicated by dashed lines. The extent of such regions could be determined using a variety of image segmentation techniques, e.g., using machine learning models trained to identify and determine the extent of cells in an image, using heuristic image processing techniques (e.g., edge detection and region-growing), or additional or alterative image segmentation techniques.

As shown, the ‘green’-color stained intracellular contents are depicted in a first component image 100c and the ‘blue’-color stained intracellular contents are depicted in a second component image 100d. A third component image 100e depicts a range of wavelengths that is sensitive to light emitted from both the ‘red’ and ‘orange’-color morphologically-specific stains (e.g., the component images are images of fluorescent emission light, and the ‘red’ and ‘orange’ stains exhibit sufficient emission of light within a range of wavelengths depicted in the third component image 100e) such that both the ‘red’ and ‘orange’-color stained intracellular contents are depicted in the third component image 100e. Similarly, a fourth component image 100f depicts a range of wavelengths that is sensitive to light emitted from both the ‘orange’ and ‘yellow-color morphologically-specific stains such that both the ‘orange’ and ‘yellow’-color stained intracellular contents are depicted in the fifth component image 100f.

So, for example, to identify the first cell 101 the first component image 100d (e.g., the dash-line-indicated portion of the first component image 100d that has been determined to correspond to the first cell 101 via segmentation, a version of the first component image 100d that has been masked to depict only the portion of the first component image 100d that has been determined to correspond to the first cell 101 via segmentation) could be applied to a rule-based model, a trained machine learning model, and/or some other variety of model or filter to determine which, if any, intracellular contents of the first cell 101 are stained ‘green.’ This could include applying the first component image 100d to a single trained machine learning model that outputs a classifier or other output indicative of which set of intracellular contents in an image are stained in the input image. In another example, the first component image 100d could be applied to a set of trained machine learning models, each model trained to generate an output that is indicative of whether the input image depicts a set of intracellular contents that the model has been trained to detect. The outputs of the set of models could then be used to determine which set(s) of intracellular contents are depicted in the input image (e.g., by selecting the highest-valued output, by selecting all outputs that are greater than a threshold value, etc.).

Such a process could be repeated for all of the possible ‘colors’ of stain in order to determine the pattern of staining (e.g., green golgi, red nucleus, blue reticulum, etc.) of each cell in a sample. The determined pattern for each cell could then be matched to a known set of stain patterns applied to the cell lines present in a sample in order to identify the cell line of origin for each cell. Were the individual raw component images are able to represent multiple different ‘colors’ (e.g., as the third composite image 100e represents both ‘red’ and ‘orange’ stains), preprocessing may be performed on the raw composite images to generate ‘color’-specific composite images. For example, an ‘orange’ composite image could be generated from the third 100e and fourth 100f composite images by determining which portions of the frame of the images both include stain (indicating that the ‘orange’ stain is present in those portions). A ‘red’-only composite image could be generated from the third 100e and fourth 100f composite images by determining which portions of the frame of the images includes stain in the third image 100e but does not include stain in the fourth image 100f (indicating that the ‘red’stain, and not the ‘orange’stain, is present in those portions).

The trained machine learning model(s) for identifying which intracellular contents of a cell are stained could be trained in a variety of ways. For example, a number of cell lines could be stained in the same intracellular contents and in the same color, and images of those incubated cells could be used, along with images of the cell lines stained in alternative contents and/or first alternative colors, to train a machine learning model to determine which intracellular contents of a cell are stained, regardless of the color of the stain. Such machine learning model(s) could be trained once (e.g., as part of an initial model training incubation experiment) and used for subsequent experiments in order to identify cells in those subsequent experiments. Additionally or alternatively, machine learning models applied to an experiment could be trained in whole or in part based on ‘test samples’ that are part of the experiment and that contain specified contents that permit identification of pattern of staining of the cells without use of the trained model. For example, a test sample could include a variety of different cell lines each stained in the same intracellular contents and in the same color, so that all of the cells in the sample are known to have been stained in the same intracellular contents.

As noted above, once the cells in each sample have been identified information can be determined in a cell-line-aware manner for the cells, across a population of samples, in order to determine an outcome of an experiment (e.g., the absolute or relative efficacy of various drugs in a candidate drug library, the effect of various genetic modifications, etc.). This information can include cell counts, dead cell counts/ratios, size size, roundness, or other conventional morphological characteristics, or conventional metrics relating to cells and their function.

Additionally or alternatively, a machine learning model can be trained to determine, based on images of cells that have been stained in an intracellular-contents-specific method, whether cells exhibit a disease state or some other physiological state or process of interest. Such stains, which provide morphological information about the cells that can be detected by the machine learning model to predict the disease or other physiological state of the cells, can be the same stains as were used to identify the cell line of the cells and/or additional stain(s) that are not used to identify the cell line of cells. Indeed, such a morphology-stained-image-based machine learning method could be applied even in contexts where cell line identification is not performed, e.g., in circumstances where only one intracellular-contents-specific stain is applied, where all cell lines are stained in the same manner/according to the same pattern, etc.

The use of such a morphologically-sensitive machine learning model to detect “diseased” cells (as separate from “control” or “non-diseased” cells) allows the efficacy of various experimental interventions (e.g., candidate drugs, genetic modifications) on the disease state or process to be investigated directly despite lack of knowledge of the underlying disease mechanism, lack of access to disease-specific cell lines, or other disease-specific knowledge or resources. This is especially beneficial when attempting to investigate (e.g., screen drug candidates) for rare diseases, where such knowledge and experimental models may be unavailable.

Such a disease (or other physiological) state-detecting machine learning model can be trained in a variety of ways. For example, known “diseased” cell lines and known control “non-diseased” cell lines could be stained (e.g., in a manner that permits identification of the cell line of the cells and/or in a manner likely to provide sufficient morphological image data to predict cell disease state but not sufficient to uniquely identify the cell lines) and imaged. The machine learning model could then be trained, based on the images of the “diseased” and “non-diseased” cells, to predict whether a given input of a cell represents the “diseased” state. As noted above, the different cell lines could be stained in a patterned manner such that the images can also be used to identify the cell line of each cell, permitting the image of the cell to be labelled as “diseased” or “non-diseased” in according with whether the cell line is it associated with is “diseased” or “non-diseased,” allowing the model to be trained on sets of images of “diseased” and “non-diseased” cells that have been exposed to essentially the same incubation and other experimental conditions by virtue of being incubated in the same sample well. Such a trained model could then be applied to predict the “disease” state of cells in additional samples (e.g., other sample wells of the same sample plate). The result of such predictions (e.g., a binary “diseased/non-diseased” class, or a continuous or otherwise varying-valued output indicative of the degree or likelihood of the disease state) could then be used to assess some experimental condition, e.g., used in combination with the predicted disease states for other cells in a sample well to determine the efficacy of a candidate drug introduced in to the sample well. Such determinations could be made based on the outputs of such a machine learning model in combination with conventional metrics determined for the cells of each cell line in each sample, e.g., cell counts, dead cell counts/ratios, cell size, roundness, or other conventional morphological metrics, etc.

Such a morphological machine learning predictor, trained to predict a disease or other physiological state or process, could be trained to operate on a single input image of a stained cell (e.g., a stain selected to provide morphological information about the cell that is considered particularly relevant to the disease process of interest). Alternatively, such a model could be configured to receive multiple input images, depicting respective different sets of intracellular contents. Such multiple different sets of intracellular contents could be stained with respective different stains having respective different ‘colors.’ Accordingly, the pattern of such ‘colors’ could, as described elsewhere herein, be specified and varied across multiple different cell lines to facilitate to identification of the cell line(s) of different cells in a sample. In such examples, the pattern of staining of a particular cell could be determined based on the imagery of the stained cell. This determined pattern could then be used to map the different ‘color’ images to the appropriate inputs of the model, such that imagery of the appropriate cell contents is input into the correct input of the model.

For example, a first input of a trained machine learning model could be configured to receive an image of the stained nucleus of a cell. Accordingly, the portion of the first composite image 100c corresponding to the first cell 101 could be applied to the first input of the model to predict the disease state of the first cell 101 (since the first composite image 100c depicts ‘green’ stained contents, and the nucleus of the first cell 101 is stained ‘green’), while the portion of the second composite image 100d corresponding to the second cell 102 could be applied to the first input of the model to predict the disease state of the second cell 102 (since the second composite image 100d depicts ‘blue’ stained contents, and the nucleus of the second cell 102 is stained ‘blue’).

As used herein, the ‘color’ of a stain refers to the detectable wavelength characteristics of the stain that allow it to be distinguished from other stains. So, for example, if the stain includes a dye, the ‘color’ of the stain could be a characteristic wavelength at which the dye scatters light (as opposed to absorbing light), e.g., a characteristic trough in an absorbance spectrum of the dye. Where the stain includes a Raman dye, the ‘color’ of the stain could be a characteristic wavelength difference by which the dye changes the wavelength of light scattered by the stain, e.g., a characteristic peak in a Raman spectrum of the Raman dye. Where the stain includes a fluorophore, the ‘color’ of the stain could be a characteristic wavelength at which the fluorophore emits light (e.g., a characteristic peak in an emission spectrum of the fluorophore) and/or a characteristic wavelength at which the fluorophore absorbs light for re-emission (e.g., a characteristic peak in an excitation spectrum of the fluorophore). In some examples where the stain includes a fluorophore, the ‘color’ of the stain could be more than one characteristic wavelength, e.g., the combination of a characteristic wavelength at which the fluorophore emits light and a characteristic wavelength at which the fluorophore absorbs light. For example, a first ‘color’ of stain could be characterized by a first excitation wavelength and a first emission wavelength, a second ‘color’ of stain could be characterized by a second, different excitation wavelength and the same first emission wavelength, a third ‘color’ of stain could be characterized by the second excitation wavelength and a second, different emission wavelength, and a fourth ‘color’ of stain could be characterized by the second excitation wavelength and the second emission wavelength.

Staining cell lines in a manner that results in specific staining of multiple different specific sets of intracellular contents could be accomplished in a variety of manners. For example, each stain could be a respective lentivirus specified to enter a cell and to selectively result in tagging of a respective set of intracellular contents (which may or may not overlap from lentivirus to lentivirus). Each of the lentiviruses could contain, include a plasmid or other genetic material coding for, and/or be conjugated to a fluorophore, dye, Raman dye, or other ‘color’-providing substance, with the mix of lentiviruses and the identity of their conjugated ‘colors’ being uniquely specified for each cell line of a set of cell lines. The lentiviruses could then be used to stain the cell line by incubating the cell line with the specified set of ‘colored’ lentiviruses. The lentiviruses (or other virus types) could include a plasmid that codes for a fusion gene that contains the cell-contents-specific targeting sequence and that also codes for a fluorescent protein or other detectable tag. In some examples, a single virus (e.g., lentivirus) could be used to tag multiple different sets of cell contents, e.g., by including a plasmid that encodes for multiple different fusion proteins. Alternative methods for inserting plasmids or other cell-contents-specific tagging substances could be used, e.g., alterative viral vectors (e.g., piggyback viruses), electroporation, etc.

### II. Illustrative Systems

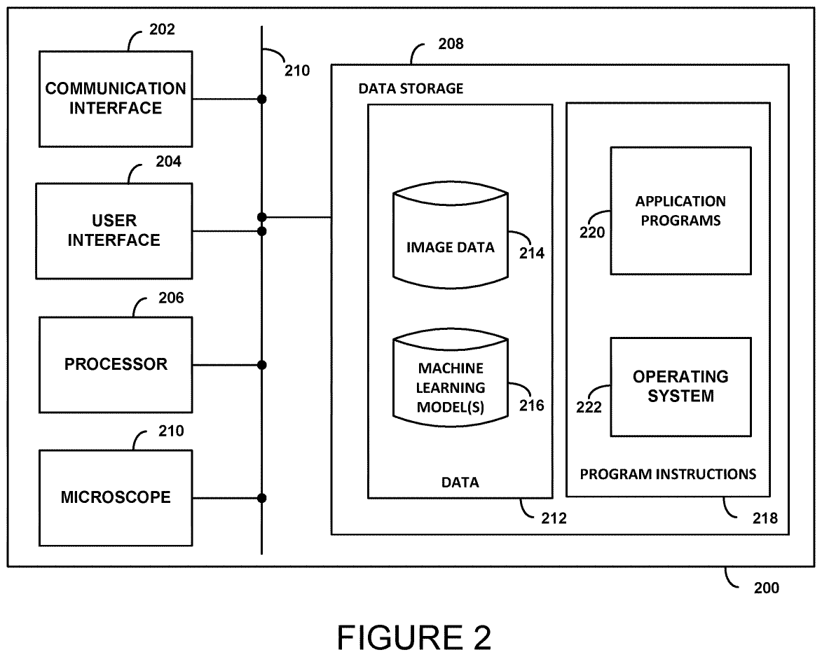

FIG. 2 illustrates an example system 200 that may be used to implement the methods described herein. By way of example and without limitation, system 200 may be a computer (such as a desktop, notebook, tablet, or handheld computer, a server), elements of a cloud computing system, an automated microscopy system (e.g., part of a high-throughput screening system that includes microscopy functionality), or some other type of device. It should be understood that system 200 may represent a physical computing device such as a server, a particular physical hardware platform on which an imaging and/or machine learning application operates in software, or other combinations of hardware and software that are configured to carry out imaging and machine learning functions as described herein. The system 200 could be a central system (e.g., a server, elements of a cloud computing system) that is configured to receive microscopy images or other information (e.g., hyperspectral images representing wells of a sample plate) from a remote system (e.g., a computing system associated with an automatic microscope system, high throughput sample handling system, or other system for generating microscope images of samples as described herein). Additionally or alternatively, the system 200 could be such a remote system, configured to transmit images to a central system and optionally to receive cell morphological data, cell counts, or other information in response.

As shown in FIG. 2, system 200 may include a communication interface 202, a user interface 204, a processor 206, a microscope 210, and data storage 208, all of which may be communicatively linked together by a system bus, network, or other connection mechanism 210. As noted above, in some examples the system 200 may lack some of these elements, e.g., the system 200 could be a central server or aspects of a cloud computing environment configured to receive microscopy images from remote system(s), in which case the system 200 could lack the microscope 210.

Communication interface 202 may function to allow system 200 to communicate, using analog or digital modulation of electric, magnetic, electromagnetic, optical, or other signals, with other devices, access networks, and/or transport networks. Thus, communication interface 202 may facilitate circuit-switched and/or packet-switched communication, such as plain old telephone service (POTS) communication and/or Internet protocol (IP) or other packetized communication. For instance, communication interface 202 may include a chipset and antenna arranged for wireless communication with a radio access network or an access point. Also, communication interface 202 may take the form of or include a wireline interface, such as an Ethernet, Universal Serial Bus (USB), or High-Definition Multimedia Interface (HDMI) port. Communication interface 202 may also take the form of or include a wireless interface, such as a Wifi, BLUETOOTH®, global positioning system (GPS), or wide-area wireless interface (e.g., WiMAX or 3GPP Long-Term Evolution (LTE)). However, other forms of physical layer interfaces and other types of standard or proprietary communication protocols may be used over communication interface 202. Furthermore, communication interface 202 may comprise multiple physical communication interfaces (e.g., a Wifi interface, a BLUETOOTH® interface, and a wide-area wireless interface). In some embodiments, communication interface 202 may function to allow system 200 to communicate with other devices, remote servers, access networks, and/or transport networks.

User interface 204 may function to allow system 200 to interact with a user or other entity, for example to receive input from and/or to provide output to the user. Thus, user interface 204 may include input components such as a keypad, keyboard, touch-sensitive or presence-sensitive panel, computer mouse, trackball, joystick, microphone, and so on. User interface 104 may also include one or more output components such as a display screen which, for example, may be combined with a presence-sensitive panel. The display screen may be based on CRT, LCD, and/or LED technologies, or other technologies now known or later developed. User interface 204 may also be configured to generate audible output(s), via a speaker, speaker jack, audio output port, audio output device, carphones, and/or other similar devices.

Processor 206 may comprise one or more general purpose processors—e.g., microprocessors—and/or one or more special purpose processors—e.g., digital signal processors (DSPs), graphics processing units (GPUs), floating point units (FPUs), network processors, tensor processing units (TPUs), or application-specific integrated circuits (ASICs). In some instances, special purpose processors may be capable of image processing, image alignment, merging images, transforming images, executing rule-based and/or machine learning models, training machine learning models, among other applications or functions. Data storage 208 may include one or more volatile and/or non-volatile storage components, such as magnetic, optical, flash, or organic storage, and may be integrated in whole or in part with processor 206. Data storage 208 may include removable and/or non-removable components.

Processor 206 may be capable of executing program instructions 218 (e.g., compiled or non-compiled program logic and/or machine code) stored in data storage 208 to carry out the various functions described herein. Therefore, data storage 208 may include a non-transitory computer-readable medium, having stored thereon program instructions that, upon execution by system 200, cause system 200 to carry out any of the methods, processes, or functions disclosed in this specification and/or the accompanying drawings. The execution of program instructions 218 by processor 206 may result in processor 206 using data 212.

By way of example, program instructions 218 may include an operating system 222 (e.g., an operating system kernel, device driver(s), and/or other modules) and one or more application programs 220 (e.g., functions for executing and/or training a machine learning model, for operating an automated microscopy system, high throughput screening system, robotic sampling handling apparatus, or other laboratory automation systems) installed on system 200. Data 212 may include image data (e.g. microscopic images of samples at one or more points in time and/or at one or more wavelengths or ranges of wavelengths) 214 and/or machine learning model(s) 216 that may be determined therefrom or obtained in some other manner.

Application programs 220 may communicate with operating system 222 through one or more application programming interfaces (APIs). These APIs may facilitate, for instance, application programs 220 transmitting or receiving information via communication interface 202, receiving and/or displaying information on user interface 204, and so on.

Application programs 220 may take the form of “apps” that could be downloadable to system 200 through one or more online application stores or application markets (via, e.g., the communication interface 202). However, application programs can also be installed on system 200 in other ways, such as via a web browser or through a physical interface (e.g., a USB port) of the system 200.

### III. Example Methods

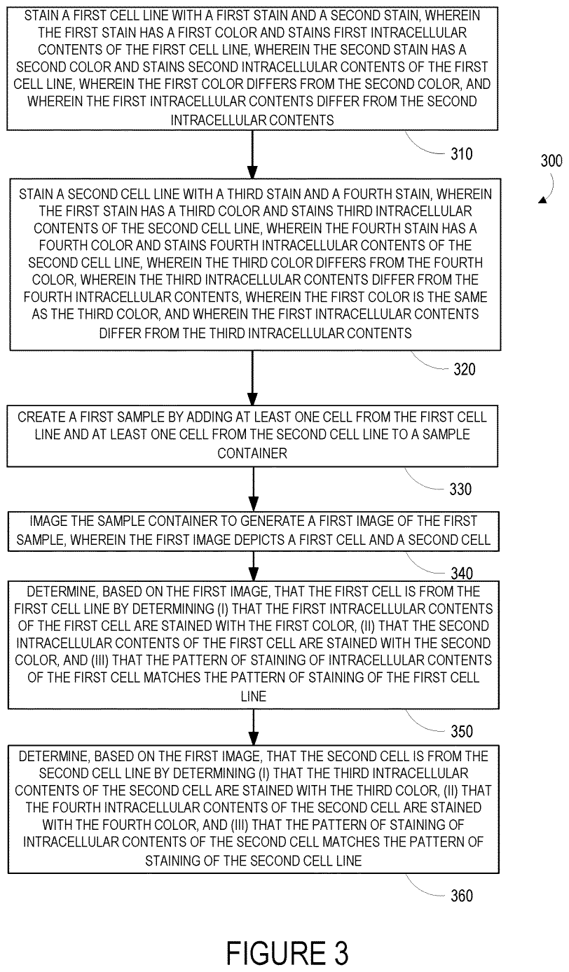

FIG. 3 is a flowchart of an example method 300. The method 300 includes staining a first cell line with a first stain and a second stain, wherein the first stain has a first color and stains first intracellular contents of the first cell line, wherein the second stain has a second color and stains second intracellular contents of the first cell line, wherein the first color differs from the second color, and wherein the first intracellular contents differ from the second intracellular contents (310). The method 300 additionally includes staining a second cell line with a third stain and a fourth stain, wherein the first stain has a third color and stains third intracellular contents of the second cell line, wherein the fourth stain has a fourth color and stains fourth intracellular contents of the second cell line, wherein the third color differs from the fourth color, wherein the third intracellular contents differ from the fourth intracellular contents, wherein the first color is the same as the third color, and wherein the first intracellular contents differ from the third intracellular contents (320). The method 300 additionally includes creating a first sample by adding at least one cell from the first cell line and at least one cell from the second cell line to a sample container (330). The method 300 additionally includes imaging the sample container to generate a first image of the first sample, wherein the first image depicts a first cell and a second cell (340). The method 300 additionally includes determining, based on the first image, that the first cell is from the first cell line by determining (i) that the first intracellular contents of the first cell are stained with the first color, (ii) that the second intracellular contents of the first cell are stained with the second color, and (iii) that the pattern of staining of intracellular contents of the first cell matches the pattern of staining of the first cell line (350). The method 300 additionally includes determining, based on the first image, that the second cell is from the second cell line by determining (i) that the third intracellular contents of the second cell are stained with the third color, (ii) that the fourth intracellular contents of the second cell are stained with the fourth color, and (iii) that the pattern of staining of intracellular contents of the second cell matches the pattern of staining of the second cell line (360). The method 300 could include additional or alternative features.

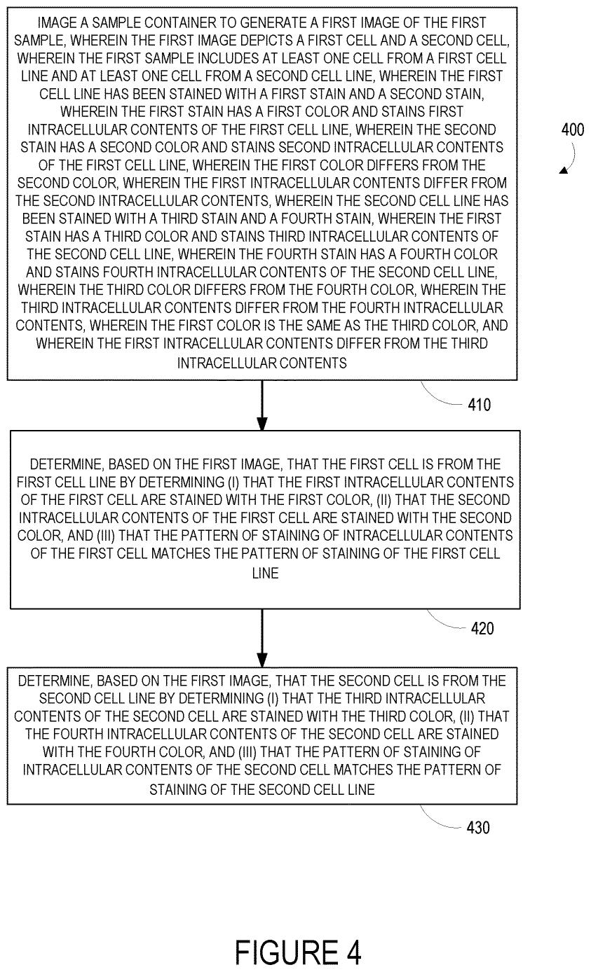

FIG. 4 is a flowchart of an example computer-implemented method 400. The method 400 includes imaging a sample container to generate a first image of the first sample, wherein the first image depicts a first cell and a second cell, wherein the first sample includes at least one cell from a first cell line and at least one cell from a second cell line, wherein the first cell line has been stained with a first stain and a second stain, wherein the first stain has a first color and stains first intracellular contents of the first cell line, wherein the second stain has a second color and stains second intracellular contents of the first cell line, wherein the first color differs from the second color, wherein the first intracellular contents differ from the second intracellular contents, wherein the second cell line has been stained with a third stain and a fourth stain, wherein the first stain has a third color and stains third intracellular contents of the second cell line, wherein the fourth stain has a fourth color and stains fourth intracellular contents of the second cell line, wherein the third color differs from the fourth color, wherein the third intracellular contents differ from the fourth intracellular contents, wherein the first color is the same as the third color, and wherein the first intracellular contents differ from the third intracellular contents (410). The method 400 additionally includes determining, based on the first image, that the first cell is from the first cell line by determining (i) that the first intracellular contents of the first cell are stained with the first color, (ii) that the second intracellular contents of the first cell are stained with the second color, and (iii) that the pattern of staining of intracellular contents of the first cell matches the pattern of staining of the first cell line (420). The method 400 additionally includes determining, based on the first image, that the second cell is from the second cell line by determining (i) that the third intracellular contents of the second cell are stained with the third color, (ii) that the fourth intracellular contents of the second cell are stained with the fourth color, and (iii) that the pattern of staining of intracellular contents of the second cell matches the pattern of staining of the second cell line (430). The method 400 could include additional or alternative features.

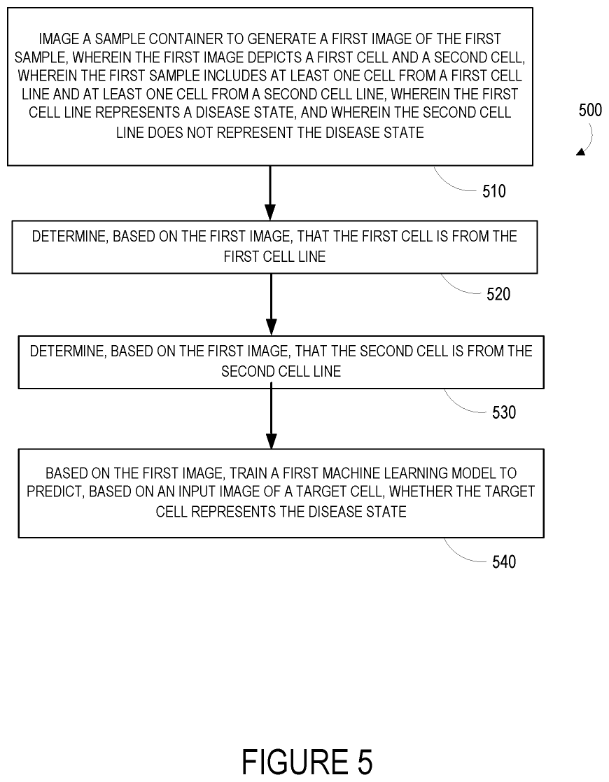

FIG. 5 is a flowchart of an example computer-implemented method 500. The method 500 includes imaging a sample container to generate a first image of the first sample, wherein the first image depicts a first cell and a second cell, wherein the first sample includes at least one cell from a first cell line and at least one cell from a second cell line, wherein the first cell line represents a disease state, and wherein the second cell line does not represent the disease state (510). The method 500 additionally includes determining, based on the first image, that the first cell is from the first cell line (520). The method 500 additionally includes determining, based on the first image, that the second cell is from the second cell line (530). The method 500 additionally includes, based on the first image, training a first machine learning model to predict, based on an input image of a target cell, whether the target cell represents the disease state (540). The method 500 could include additional or alternative features.

### IV. Example Machine Learning Models and Training Thereof

A machine learning model as described herein may include, but is not limited to: an artificial neural network (e.g., a herein-described convolutional neural networks, a recurrent neural network, a Bayesian network, a hidden Markov model, a Markov decision process, a logistic regression function, a support vector machine, a suitable statistical machine learning algorithm, and/or a heuristic machine learning system), a support vector machine, a regression tree, an ensemble of regression trees (also referred to as a regression forest), a decision tree, an ensemble of decision trees (also referred to as a decision forest), or some other machine learning model architecture or combination of architectures.

An artificial neural network (ANN) could be configured in a variety of ways. For example, the ANN could include two or more layers, could include units having linear, logarithmic, or otherwise-specified output functions, could include fully or otherwise-connected neurons, could include recurrent and/or feed-forward connections between neurons in different layers, could include filters or other elements to process input information and/or information passing between layers, or could be configured in some other way to facilitate the generation of predicted color palettes based on input images.

An ANN could include one or more filters that could be applied to the input (or to the output of some intermediate layer of the ANN) and the outputs of such filters could then be applied to the inputs of one or more neurons of the ANN. For example, such an ANN could be or could include a convolutional neural network (CNN). Convolutional neural networks are a variety of ANNs that are configured to facilitate ANN-based classification or other processing based on images or other large-dimensional inputs whose elements are organized within two or more dimensions. The organization of the ANN along these dimensions may be related to some structure in the input (e.g., as relative location within the two-dimensional space of an image can be related to similarity between pixels of the image).

In example embodiments, a CNN includes at least one two-dimensional (or higher-dimensional) filter that is applied to an input; the filtered input is then applied to neurons of the CNN (e.g., of a convolutional layer of the CNN). The convolution of such a filter and an input could represent the color values of a pixel or a group of pixels from the input, in embodiments where the input is an image. A set of neurons of a CNN could receive respective inputs that are determined by applying the same filter to an input. Additionally or alternatively, a set of neurons of a CNN could be associated with respective different filters and could receive respective inputs that are determined by applying the respective filter to the input. Such filters could be trained during training of the CNN or could be pre-specified. For example, such filters could represent wavelet filters, center-surround filters, biologically-inspired filter kernels (e.g., from studies of animal visual processing receptive fields), or some other pre-specified filter patterns.

A CNN or other variety of ANN could include multiple convolutional layers (e.g., corresponding to respective different filters and/or features), pooling layers, rectification layers, fully connected layers, or other types of layers. Convolutional layers of a CNN represent convolution of an input image, or of some other input (e.g., of a filtered, downsampled, or otherwise-processed version of an input image), with a filter. Pooling layers of a CNN apply non-linear downsampling to higher layers of the CNN, e.g., by applying a maximum, average, L2-norm, or other pooling function to a subset of neurons, outputs, or other features of the higher layer(s) of the CNN. Rectification layers of a CNN apply a rectifying nonlinear function (e.g., a non-saturating activation function, a sigmoid function) to outputs of a higher layer. Fully connected layers of a CNN receive inputs from many or all of the neurons in one or more higher layers of the CNN. The outputs of neurons of one or more fully connected layers (e.g., a final layer of an ANN or CNN) could be used to determine information about areas of an input image (e.g., for each of the pixels of an input image) or for the image as a whole.

Neurons in a CNN can be organized according to corresponding dimensions of the input. For example, where the input is an image (a two-dimensional input, or a three-dimensional input where the color channels of the image are arranged along a third dimension), neurons of the CNN (e.g., of an input layer of the CNN, of a pooling layer of the CNN) could correspond to locations in the two-dimensional input image. Connections between neurons and/or filters in different layers of the CNN could be related to such locations. For example, a neuron in a convolutional layer of the CNN could receive an input that is based on a convolution of a filter with a portion of the input image, or with a portion of some other layer of the CNN, that is at a location proximate to the location of the convolutional-layer neuron. In another example, a neuron in a pooling layer of the CNN could receive inputs from neurons, in a layer higher than the pooling layer (e.g., in a convolutional layer, in a higher pooling layer), that have locations that are proximate to the location of the pooling-layer neuron.

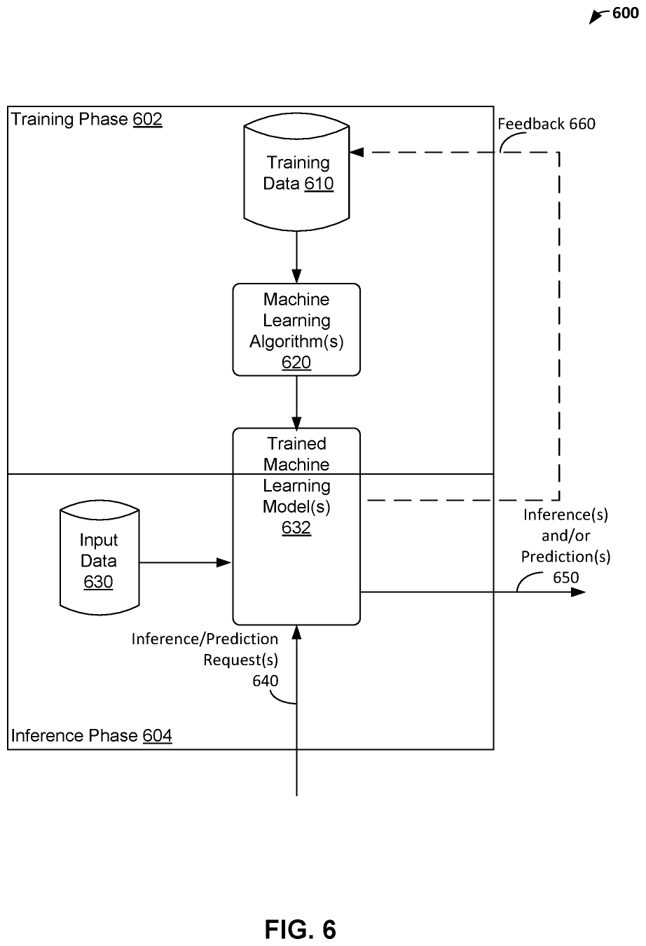

FIG. 6 shows diagram 600 illustrating a training phase 602 and an inference phase 604 of trained machine learning model(s) 632, in accordance with example embodiments. Some machine learning techniques involve training one or more machine learning algorithms, on an input set of training data to recognize patterns in the training data and provide output inferences and/or predictions about (patterns in the) training data. Such output could take the form of filtered or otherwise modified versions of the input, e.g., an input image could be a color-swapped version of an image of a cell, in order to prevent the model being trained from associating certain morphological features with specific color inputs. The resulting trained machine learning algorithm can be termed as a trained machine learning model. For example, FIG. 6 shows training phase 602 where one or more machine learning algorithms 620 are being trained on training data 610 to become trained machine learning model 632. Then, during inference phase 604, trained machine learning model 632 can receive input data 630 and one or more inference/prediction requests 640 (perhaps as part of input data 630) and responsively provide as an output one or more inferences and/or predictions 650.

As such, trained machine learning model(s) 632 can include one or more models of one or more machine learning algorithms 620. Machine learning algorithm(s) 620 may include, but are not limited to: an artificial neural network (e.g., herein-described convolutional neural networks, a recurrent neural network, a Bayesian network, a hidden Markov model, a Markov decision process, a logistic regression function, a support vector machine, a suitable statistical machine learning algorithm, and/or a heuristic machine learning system), a support vector machine, a regression tree, an ensemble of regression trees (also referred to as a regression forest), a decision tree, an ensemble of decision trees (also referred to as a decision forest), or some other machine learning model architecture or combination of architectures. Machine learning algorithm(s) 620 may be supervised or unsupervised, and may implement any suitable combination of online and offline learning.

In some examples, machine learning algorithm(s) 620 and/or trained machine learning model(s) 632 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 620 and/or trained machine learning model(s) 632. In some examples, trained machine learning model(s) 632 can be trained, reside and execute to provide inferences on a particular computing device, and/or otherwise can make inferences for the particular computing device.

During training phase 602, machine learning algorithm(s) 620 can be trained by providing at least training data 610 as training input using unsupervised, supervised, semi-supervised, and/or reinforcement learning techniques. Unsupervised learning involves providing a portion (or all) of training data 610 to machine learning algorithm(s) 620 and machine learning algorithm(s) 620 determining one or more output inferences based on the provided portion (or all) of training data 610. Supervised learning involves providing a portion of training data 610 to machine learning algorithm(s) 620, with machine learning algorithm(s) 620 determining one or more output inferences based on the provided portion of training data 610, and the output inference(s) are either accepted or corrected based on correct results associated with training data 610. In some examples, supervised learning of machine learning algorithm(s) 620 can be governed by a set of rules and/or a set of labels for the training input, and the set of rules and/or set of labels may be used to correct inferences of machine learning algorithm(s) 620.

Semi-supervised learning involves having correct results for part, but not all, of training data 610. During semi-supervised learning, supervised learning is used for a portion of training data 610 having correct results, and unsupervised learning is used for a portion of training data 610 not having correct results. Reinforcement learning involves machine learning algorithm(s) 620 receiving a reward signal regarding a prior inference, where the reward signal can be a numerical value. During reinforcement learning, machine learning algorithm(s) 620 can output an inference and receive a reward signal in response, where machine learning algorithm(s) 620 are configured to try to maximize the numerical value of the reward signal. In some examples, reinforcement learning also utilizes a value function that provides a numerical value representing an expected total of the numerical values provided by the reward signal over time. In some examples, machine learning algorithm(s) 620 and/or trained machine learning model(s) 632 can be trained using other machine learning techniques, including but not limited to, incremental learning and curriculum learning.

In some examples, machine learning algorithm(s) 620 and/or trained machine learning model(s) 632 can use transfer learning techniques. For example, transfer learning techniques can involve trained machine learning model(s) 632 being pre-trained on one set of data and additionally trained using training data 610. More particularly, machine learning algorithm(s) 620 can be pre-trained on data from one or more computing devices and a resulting trained machine learning model provided to computing device CD1, where CD1 is intended to execute the trained machine learning model during inference phase 604. Then, during training phase 602, the pre-trained machine learning model can be additionally trained using training data 610, where training data 610 can be derived from kernel and non-kernel data of computing device CD1. This further training of the machine learning algorithm(s) 620 and/or the pre-trained machine learning model using training data 610 of CDI's data can be performed using either supervised or unsupervised learning. Once machine learning algorithm(s) 620 and/or the pre-trained machine learning model has been trained on at least training data 610, training phase 602 can be completed. The trained resulting machine learning model can be utilized as at least one of trained machine learning model(s) 632.

In particular, once training phase 602 has been completed, trained machine learning model(s) 632 can be provided to a computing device, if not already on the computing device. Inference phase 604 can begin after trained machine learning model(s) 432 are provided to computing device CD1.

During inference phase 604, trained machine learning model(s) 632 can receive input data 630 and generate and output one or more corresponding inferences and/or predictions 650 about input data 630. As such, input data 630 can be used as an input to trained machine learning model(s) 632 for providing corresponding inference(s) and/or prediction(s) 650 to kernel components and non-kernel components. For example, trained machine learning model(s) 632 can generate inference(s) and/or prediction(s) 650 in response to one or more inference/prediction requests 640. In some examples, trained machine learning model(s) 632 can be executed by a portion of other software. For example, trained machine learning model(s) 632 can be executed by an inference or prediction daemon to be readily available to provide inferences and/or predictions upon request. Input data 630 can include data from computing device CDI executing trained machine learning model(s) 632 and/or input data from one or more computing devices other than CD1.

Input data 630 can include a collection of images provided by one or more sources. The collection of images can include video frames, images resident on computing device CDI, and/or other images. Other types of input data are possible as well.

Inference(s) and/or prediction(s) 650 can include output images, output intermediate images, output vectors embedded in a multi-dimensional space, numerical values, classifier outputs indicative of a type of morphological staining represented by an input image, classifier outputs indicative of whether a disease state is indication and/or a degree of disease state exhibited by a cell, and/or other output data produced by trained machine learning model(s) 632 operating on input data 630 (and training data 610). In some examples, trained machine learning model(s) 632 can use output inference(s) and/or prediction(s) 650 as input feedback 660. Trained machine learning model(s) 632 can also rely on past inferences as inputs for generating new inferences.

### V. Conclusion

The particular arrangements shown in the Figures should not be viewed as limiting. It should be understood that other embodiments may include more or less of each element shown in a given Figure. Further, some of the illustrated elements may be combined or omitted. Yet further, an exemplary embodiment may include elements that are not illustrated in the Figures.

Additionally, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

1. A method comprising:
staining a first cell line with a first stain and a second stain, wherein the first stain has a first color and stains first intracellular contents of the first cell line, wherein the second stain has a second color and stains second intracellular contents of the first cell line, wherein the first color differs from the second color, and wherein the first intracellular contents differ from the second intracellular contents;
staining a second cell line with a third stain and a fourth stain, wherein the first stain has a third color and stains third intracellular contents of the second cell line, wherein the fourth stain has a fourth color and stains fourth intracellular contents of the second cell line, wherein the third color differs from the fourth color, wherein the third intracellular contents differ from the fourth intracellular contents, wherein the first color is the same as the third color, and wherein the first intracellular contents differ from the third intracellular contents;
creating a first sample by adding at least one cell from the first cell line and at least one cell from the second cell line to a sample container;
imaging the sample container to generate a first image of the first sample, wherein the first image depicts a first cell and a second cell;
determining, based on the first image, that the first cell is from the first cell line by determining (i) that the first intracellular contents of the first cell are stained with the first color, (ii) that the second intracellular contents of the first cell are stained with the second color, and (iii) that the pattern of staining of intracellular contents of the first cell matches the pattern of staining of the first cell line; and
determining, based on the first image, that the second cell is from the second cell line by determining (i) that the third intracellular contents of the second cell are stained with the third color, (ii) that the fourth intracellular contents of the second cell are stained with the fourth color, and (iii) that the pattern of staining of intracellular contents of the second cell matches the pattern of staining of the second cell line.

2. The method of claim 1, wherein staining the first cell line with the first stain comprises applying, to the first cell line, a lentivirus that enters the cell and that contains a plasmid that codes for a substance that preferentially binds to the first intracellular contents and that also codes for a substance that has the first color.

3. The method of claim 2, wherein the plasmid coding for a substance that preferentially binds to the first intracellular contents comprises the plasmid coding for a first fusion protein that preferentially binds to the first intracellular contents and wherein the plasmid coding for a substance that has the first color comprises the plasmid coding for a fluorescent protein.

4. The method of claim 1, wherein the first cell line represents a disease state, wherein the second cell line does not represent the disease state, and wherein the method further comprises:
based on the first image, training a machine learning model to predict, based on an input image of a target cell, whether the target cell represents the disease state.

5. The method of claim 4, further comprising:
imaging a second sample container that contains a second sample to generate a second image of the second sample, wherein the second sample contains at least one cell from a third cell line, and wherein the second image depicts a third cell from the third cell line;
applying the second image to the trained machine learning model to predict whether the third cell represents the disease state.

6. The method of claim 5, wherein the third cell line represents the disease state, wherein the second sample has been treated with a candidate therapy, and wherein the method further comprises:
determining, based on the prediction of whether the third cell represents the disease state, an efficacy of the candidate therapy.

7-12. (canceled)

13. The method of claim 1, wherein the first intracellular contents represent at least one of a nucleus, a ribosome, a rough endoplasmic reticulum, a smooth endoplasmic reticulum, a golgi apparatus, a peroxisome, a nuclear membrane, a cell membrane, an actin filament, a centrosome, a myosin filament, a vacuole, a mitochondrion, a secretory vesicle, a trans-membrane protein, or a peripheral membrane protein.

14. The method of claim 1, wherein the first stain comprises at least one of a dye, a fluorophore, or a raman dye, and wherein the first color is a characteristic peak or trough of at least one of an absorption spectrum, a reflectance spectrum, a scattering spectrum, an excitation spectrum, an emission spectrum, or a Raman spectrum of the first stain.

15. The method of claim 1, further comprising:
subsequent to imaging the sample container to generate a first image of the first sample, incubating the sample container for a period of time;
subsequent to incubating the sample container for a period of time, imaging the sample container to generate a second image of the first sample, wherein the second image depicts the first cell from the first cell line; and
determining, based on the second image, that the first cell depicted in the second image is the same cell as the first cell depicted in the first image by determining (i) that the first intracellular contents of the first cell depicted in the second image are stained with the first color, (ii) that the second intracellular contents of the first cell depicted in the second image are stained with the second color, and (iii) that the pattern of staining of intracellular contents of the first cell depicted in the second image matches the pattern of staining of the first cell depicted in the first image.

16. A computer-implemented method comprising:
imaging a sample container to generate a first image of the first sample, wherein the first image depicts a first cell and a second cell, wherein the first sample includes at least one cell from a first cell line and at least one cell from a second cell line, wherein the first cell line has been stained with a first stain and a second stain, wherein the first stain has a first color and stains first intracellular contents of the first cell line, wherein the second stain has a second color and stains second intracellular contents of the first cell line, wherein the first color differs from the second color, wherein the first intracellular contents differ from the second intracellular contents, wherein the second cell line has been stained with a third stain and a fourth stain, wherein the first stain has a third color and stains third intracellular contents of the second cell line, wherein the fourth stain has a fourth color and stains fourth intracellular contents of the second cell line, wherein the third color differs from the fourth color, wherein the third intracellular contents differ from the fourth intracellular contents, wherein the first color is the same as the third color, and wherein the first intracellular contents differ from the third intracellular contents;
determining, based on the first image, that the first cell is from the first cell line by determining (i) that the first intracellular contents of the first cell are stained with the first color, (ii) that the second intracellular contents of the first cell are stained with the second color, and (iii) that the pattern of staining of intracellular contents of the first cell matches the pattern of staining of the first cell line; and
determining, based on the first image, that the second cell is from the second cell line by determining (i) that the third intracellular contents of the second cell are stained with the third color, (ii) that the fourth intracellular contents of the second cell are stained with the fourth color, and (iii) that the pattern of staining of intracellular contents of the second cell matches the pattern of staining of the second cell line.

17. The computer-implemented method of claim 16, wherein the first cell line represents a disease state, wherein the second cell line does not represent the disease state, and wherein the computer-implemented method further comprises:
based on the first image, training a machine learning model to predict, based on an input image of a target cell, whether the target cell represents the disease state.

18. The computer-implemented method of claim 17, further comprising:
imaging a second sample container that contains a second sample to generate a second image of the second sample, wherein the second sample contains at least one cell from a third cell line, and wherein the second image depicts a third cell from the third cell line;
applying the second image to the trained machine learning model to predict whether the third cell represents the disease state.

19. The computer-implemented method of claim 18, wherein the third cell line represents the disease state, wherein the second sample has been treated with a candidate therapy, and wherein the computer-implemented method further comprises:
determining, based on the prediction of whether the third cell represents the disease state, an efficacy of the candidate therapy.

20. The computer-implemented method of claim 16, further comprising:
segmenting the first image to determine a region of the first image that represents the first cell,
wherein determining that the first intracellular contents of the first cell are stained with the first color comprises determining, based on the determined region of the first image that represents the first cell, that the first intracellular contents of the first cell are stained with the first color, and
wherein determining that the second intracellular contents of the first cell are stained with the second color comprises determining, based on the determined region of the first image that represents the first cell, that the second intracellular contents of the first cell are stained with the second color.

21. The computer-implemented method of claim 16, wherein the first image of the first sample is a hyperspectral image comprising a plurality of component images representing respective ranges of wavelengths of light imaged from the first sample, wherein determining that the first intracellular contents of the first cell are stained with the first color comprises applying a first component image of the plurality of component images that represents the first color to a first trained machine learning model to predict that the first intracellular contents of the first cell are stained with the first color, and wherein determining that the second intracellular contents of the first cell are stained with the second color comprises applying a second component image of the plurality of component images that represents the second color to the first trained machine learning model to predict that the second intracellular contents of the first cell are stained with the second color.

22. The computer-implemented method of claim 21, further comprising:
applying the first and second component images to a second trained machine learning model to predict whether the first cell represents a disease state, wherein the second trained machine learning model receives a first image input that represents the first intracellular contents and a second image input that represents the first intracellular contents, and wherein applying the first and second component images to a second trained machine learning model comprises mapping the first and second component images to the first and second image inputs, respectively, based on the predictions that the first intracellular contents of the first cell are stained with the first color and that the second intracellular contents of the first cell are stained with the second color.

23. The computer-implemented method of claim 16, wherein the first cell line represents a disease state, wherein the first sample has been treated with a candidate therapy, and wherein the computer-implemented method further comprises:
applying the first image to a trained machine learning model to predict whether the first cell represents the disease state;
determining, based on the prediction of whether the first cell represents the disease state, an efficacy of the candidate therapy.

24. The computer-implemented method of claim 16, wherein the first cell line has been stained with a fifth stain, wherein the fifth stain stains fifth intracellular contents of the first cell line, and wherein the computer-implemented method further comprises:
applying the first image to a trained machine learning model to predict, based on the staining of the first cell by the fifth stain, whether the first cell represents a disease state.

25. The computer-implemented method of claim 24, wherein the first cell line represents the disease state, wherein the first sample has been treated with a candidate therapy, and wherein the computer-implemented method further comprises:
determining, based on the prediction of whether the first cell represents the disease state, an efficacy of the candidate therapy.

26. (canceled)

27. A computer-implemented method comprising:
imaging a sample container to generate a first image of the first sample, wherein the first image depicts a first cell and a second cell, wherein the first sample includes at least one cell from a first cell line and at least one cell from a second cell line, wherein the first cell line represents a disease state, and wherein the second cell line does not represent the disease state;
determining, based on the first image, that the first cell is from the first cell line;
determining, based on the first image, that the second cell is from the second cell line; and
based on the first image, training a first machine learning model to predict, based on an input image of a target cell, whether the target cell represents the disease state.

28-32. (canceled)
